(19) United States
(12) Patent Application Publication
(10) Pub. No.: US 2026/0103243 A1
(43) Pub. Date: Apr. 16, 2026

(54) QUICK-RELEASE BODY ATTACHMENT SYSTEM FOR A MODEL VEHICLE

(71) Applicant: Horizon Hobby, Champaign, IL (US)

(72) Inventors: Wojciech Nodzykowski, Kanagawa-ken (JP); Jami Jones, Derbyshire (GB); Fabien Simonini, Leicester (GB); Jason Dearden, Vokovice (CZ)

(21) Appl. No.: 19/357,229

(22) Filed: Oct. 14, 2025

Related U.S. Application Data
(60) Provisional application No. 63/707,152, filed on Oct. 14, 2024.

(51) Int. Cl. B62D 24/02; A63H 17/26; A63H 30/00

(52) U.S. Cl. CPC B62D 24/02; A63H 17/262; A63H 17/264; A63H 30/00

(57) ABSTRACT

A quick-release body attachment system for model vehicles, wherein one or more grooved pegs are inserted into one or more alignment holes of a cantilever straight spring assembly, as the vehicle body is attached to the vehicle chassis. Once the grooved pegs are fully inserted, cantilever straight springs spring into groove of the peg, securing the vehicle body to the vehicle chassis. Applying force to the release handle mounted to the cantilever straight spring, release the spring from the groove of the peg, allowing the vehicle body to detach from the vehicle chassis.

### CROSS-REFERENCE TO RELATED APPLICATION(S)

This application claims the benefit under 35 USC § 119 to U.S. Provisional Application 63/707,152, filed Oct. 14, 2024, and entitled “QUICK-RELEASE BODY ATTACHMENT SYSTEM FOR A MODEL VEHICLE,” which is incorporated herein by reference in its entirety.

### BACKGROUND

Radio-controlled (RC) model vehicles have been mass-produced for the last 50 years. They come in various forms, e.g., automobiles, boats, airplanes, and helicopters. One of the largest markets for RC model vehicles is the market for model automotive vehicles. These vehicles are intended to realistically—to varying degrees—depict their full-scale automotive counterparts.

Unlike full-scale vehicles, model vehicles have little need for the cab and storage compartments of the automotive vehicle. To reduce production costs and ease changing vehicle body models, model vehicles often separate the vehicle body from the chassis. The chassis is made from several rigid plastic and metal parts. Whereas the vehicle body consists of only a thin molded plastic shell in a form giving the appearance a full-scale vehicle body. The thin molded plastic allows the sides and corners of the vehicle body to flex and bend without breaking during normal operation which may involve crashing or rolling.

RC model vehicles require frequent removal and re-attachment of the vehicle body for battery recharging, maintenance, or customization purposes. Existing attachment mechanisms may be timely to operate, cumbersome, quickly degrade with wear and tear, or require two hands to operate.

In the industry of hobbyist RC model vehicles, the most common form of vehicle body attachment is a system that includes pillars mounted to the chassis, holes in the vehicle body, and retaining clips. The vehicle body is attached by lining up the holes in the vehicle body to their corresponding pillars mounted to the chassis, pressing down on the vehicle body, then inserting the retaining clips into slots in the portion of the pillars that protrude past the vehicle body.

To maintain the model vehicle's realism, the pillars and retaining clips must be very small. The pillars may break during crashes, rolls, or aggressive handling of the model vehicle. The retaining clips consist of a bent wire approximately 0.5 mm in diameter and around 0.5 cm in length. The flexibility along the centerline, specifically at the simulated hood and trunk or truckbed sections, may allow the body to flex and tear around the mounting holes in the vehicle body during such crashes and rolls.

Furthermore, the retaining clips can be difficult to insert and are easily lost. Worse, the retaining clips can be a choking hazard for children.

The pillar and retaining clip systems are time-consuming, requiring the hobbyist to remove and re-insert two to four retaining clips each time the vehicle body is removed and attached. This two-handed process unnecessarily burdens the hobbyist each time they need to access vehicle parts on the chassis, most frequently the battery for recharging or changing.

Thus, there is a need for an improved attachment mechanism that provides a more efficient, reliable, and secure fastening of vehicle bodies to their chassis.

### SUMMARY

The principle aim of the new body design is to remove the need for a traditional RC body mount and body clips so that the body—particularly the hood surfaces—doesn't require holes that would make them appear less like full-size vehicles while simultaneously providing better shock absorption and support and more efficient vehicle body removal and attachment than previous body mounting systems.

A quick-release model vehicle body attachment mechanism for securely fastening a vehicle body to a chassis of a remote-control model vehicle is described herein. The mechanism includes features for quick and reliable attachment and detachment of the vehicle body, enhancing operator convenience, safety, and efficiency. More specifically, the model vehicle attachment mechanism comprises of one or more cantilever straight spring assemblies paired to one or more grooved peg assemblies. The grooved peg assembly comprises of a body mount and one or more grooved pegs aligned to the cantilever straight spring assembly. The cantilever straight spring assembly comprises of a body mount, alignment holes matched to align in the closed position with the grooved pegs of the grooved pegs assembly, and one or more straight springs, and one or more release handles or buttons. When the vehicle body is aligned above the vehicle chassis, the vehicle body may be pressed onto the vehicle chassis to lock the vehicle body in place on the chassis. This is achieved when the grooved pegs pass through their respective alignment holes and the straight spring cantilevers into the peg groove. The straight spring remains in the peg groove until the operator moves one or more release handles or buttons, which release the straight spring from the peg groove. The vehicle body may then be lifted by the operator or pushed by a separate spring mechanism off the vehicle chassis.

The foregoing summary is illustrative only and is not intended to be in any way limiting. In addition to the illustrative aspects, embodiments, and features described above, further aspects, embodiments, and features will become apparent by reference to the figures and the following detailed description.

Other embodiments of these aspects include corresponding systems and apparatus, configured to perform the actions of the methods.

These and other embodiments may each optionally include one or more of the following features. For instance, the RC model vehicle may comprise of one or more other attachment mechanisms to assist the attachment of the present invention in aligning or securing the vehicle body to the vehicle chassis.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 illustrates an RC model vehicle with the vehicle body separated from the vehicle chassis incorporating a first and second vehicle body fastener, according to an example embodiment;

FIG. 2A illustrates an RC model vehicle with a front vehicle body fastener partially secured and rear quick-release body attachment mechanism in the unsecured position, according to an example embodiment;

FIG. 2B illustrates an RC model vehicle with a front vehicle body fastener and rear quick-release body attachment mechanism, both, in the secured position, according to an example embodiment;

FIG. 3 illustrates the quick-release body attachment mechanism in cut-out front view;

FIG. 4A illustrates a top-down view of the cantilever straight spring assembly in the closed position, according to an example embodiment;

FIG. 4B illustrates a top-down view of the cantilever straight spring assembly in the open position, according to an example embodiment;

FIG. 5A illustrates a side view of the grooved alignment peg assembly with a flat groove, according to an example embodiment;

FIG. 5B illustrates a side view of a grooved peg assembly with a negative angle groove, according to an example embodiment;

FIG. 6A illustrates a side view of the quick-release body attachment mechanism in the open position, according to an example embodiment; and

FIG. 6B illustrates a side view of the quick-release body attachment mechanism in the closed position, according to an example embodiment.

### DESCRIPTION OF PARTICULAR EMBODIMENT(S)

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

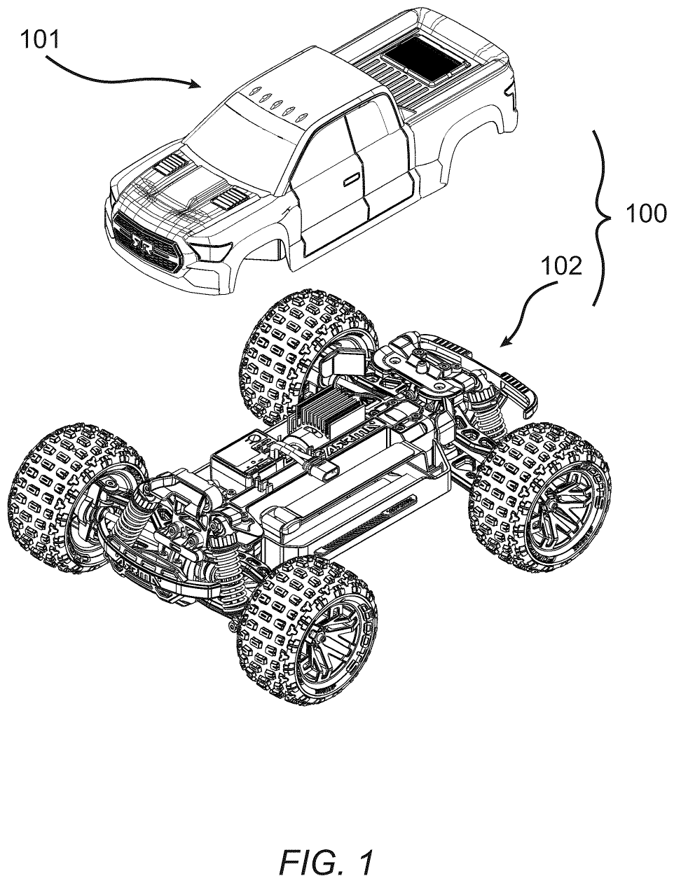

FIG. 1 illustrates an RC model vehicle 100 according to an example embodiment. The RC model vehicle 100 comprises a vehicle body 101 and a vehicle chassis 102. In the example embodiment, the vehicle body 101 is a flexible single-piece plastic shell shaped to mimic a pick-up truck body with vehicle body 101 attachment assemblies mounted underneath the vehicle body 101. The vehicle chassis 102 houses components including the battery, electronic speed controller (ESC), electric motor, vehicle suspension, and tires, among others.

The vehicle body 101 primarily protects the internal components housed on or in the vehicle chassis 102. Secondarily, a vehicle body 101 that mimics the look of a full-scale vehicle is preferred by hobbyists. As such, the vehicle body 101 should be securely attached to the vehicle chassis 102 at all times during operation. The disclosed embodiments allow the operator an efficient manner for quickly accessing the components housing on or in the vehicle chassis 102 and a secure attachment of the vehicle body 101 to the vehicle chassis 102 during operation.

When the vehicle body 101 and vehicle chassis 102 are separated, the operator can access internal components of the RC model vehicle 100. Prior to operating the RC model vehicle 100 and during its storage, the battery should be disconnected from the ESC. The operator must connect the battery to the ESC and disconnect the battery at the end of use for storage, which both require access to the top of the vehicle chassis 102. Furthermore, the operator must access the ESC to turn it on and off when starting and ending, respectively, use of the RC model vehicle 100.

Other embodiments may be RC model vehicles 100 of different types, such as, cars, boats, or motorcycles. In the example of an RC model boat, the sides and bottom of the boat hull may form the vehicle chassis 102, and the vehicle body 101 would be the top of the boat hull. For the RC model motorcycle, the seat with or without an accompanying simulated rider may form the vehicle body 101, and the remaining motorcycle parts form the vehicle chassis 102. Furthermore, some embodiments may have a vehicle body 101 shell comprising of multiple sections or parts. These sections of the vehicle body 101 may take the form of an exterior shell and interior components, such as, a simulated vehicle interior cab and driver. Furthermore, the vehicle body 101 may be separated into sections in other manners, such as, front, middle, and rear sections.

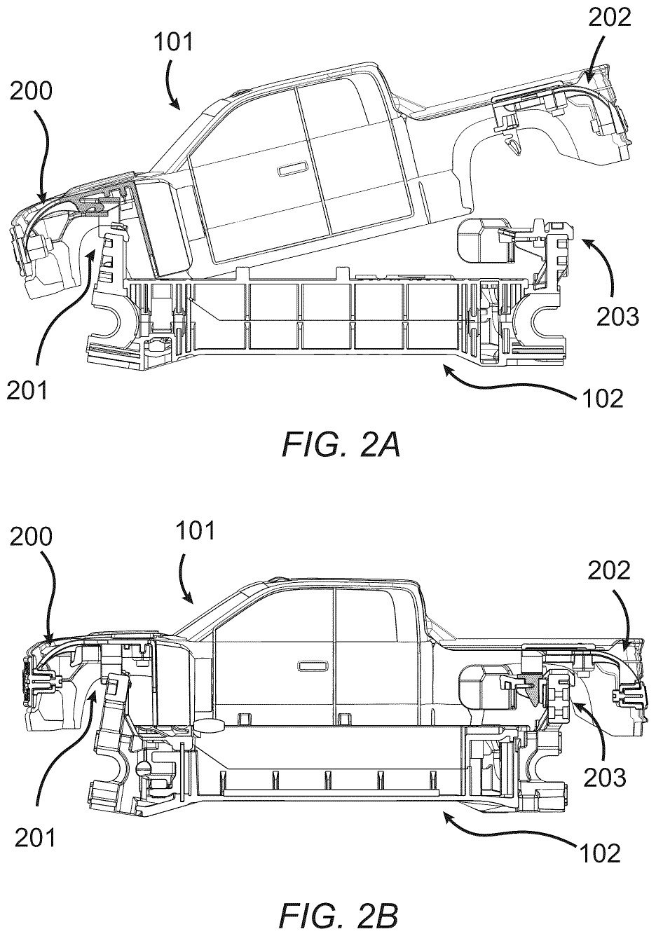

FIGS. 2A and 2B, each, comprise of a vehicle body 101, a vehicle chassis 102, a tongue attachment assembly 200, a tongue receiver assembly 201, a grooved peg assembly 202, and cantilever straight spring assembly 203. FIG. 2A illustrates the vehicle body with the front attachment mechanism, comprising the tongue attachment assembly 200 and tongue receiver assembly 201, in the partially closed position and the rear attachment mechanism, comprising the grooved peg 202 and the cantilever straight spring assembly 203 in the open position.

In the example embodiment, the tongue attachment assembly 201 is mounted through the simulated hood secured by two rigid plastic front fastener retainers shaped to mimic hood air vents. The grooved peg assembly 202 mounted through the simulated bed secured by a rigid plastic rear fastener retainer shaped to mimic a flat section of the truck bed. The shapes of the tongue in the tongue attachment assembly and receiver in the tongue receiver assembly allow the tongue to slide into the receiver with the vehicle body 101 slightly forward of the vehicle chassis 101 while the vehicle body 101 is tilted at a decline. The receiver and tongue are aligned on the vehicle chassis 102 and vehicle body 101, respectively, to cause the front of the vehicle body 101 to correctly align laterally with the front of the vehicle chassis 102. Furthermore, the receiver is placed longitudinally on the vehicle chassis 102 to stop the vehicle body's 101 rearward movement as the vehicle body 101 is hinged down along the medial axis of the model vehicle 100, and in such a manner, that the grooved peg assembly 202 and cantilever straight spring assembly 203 align longitudinally for mating when that rearmost stop is met.

Other example embodiments may use only use one or more cantilever straight spring assemblies 203 mated to grooved peg assemblies 202 as the sole means of attaching the vehicle body 101 to the vehicle chassis 102. Some embodiments may mount the one or more cantilever straight spring assemblies 203 and grooved peg assemblies 202 in different locations, such as on one or each side of the model vehicle 100 or may mount cantilever straight spring assembly 203 to the vehicle body 101 and the grooved peg assembly 202 to the vehicle chassis 102. Other embodiments may use existing or novel attachment mechanisms—other than the example tongue attachment assembly 200 and tongue receiver assembly 201—to assist in the attachment of the vehicle body 101 to the vehicle chassis 102.

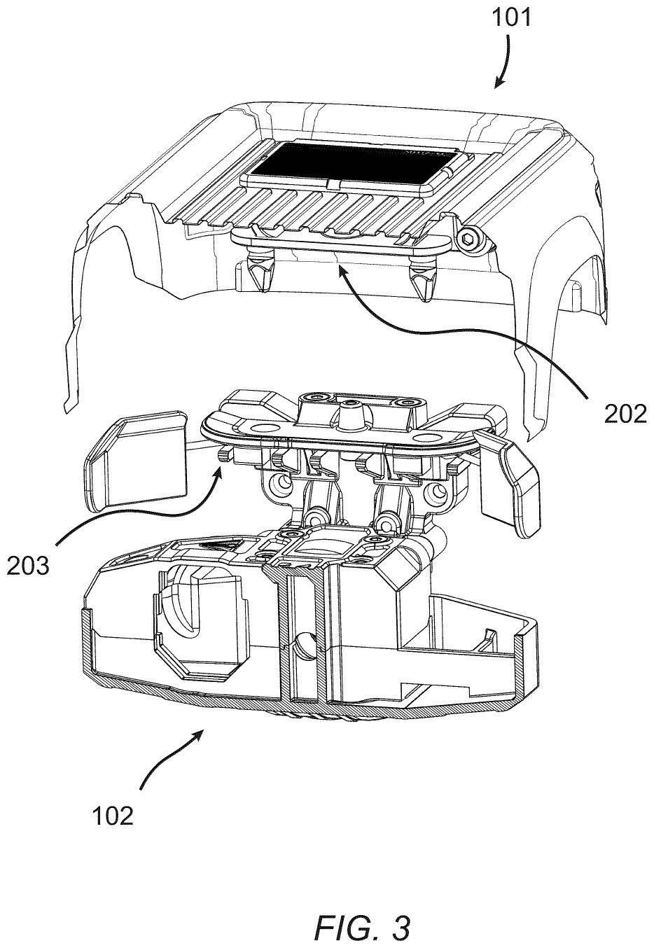

FIG. 3 illustrates the quick-release body attachment mechanism in a cut-out view along the medial-vertical plane of the RC model vehicle 100. FIG. 3 comprises the vehicle body 101, vehicle chassis 102, grooved peg assembly 202, and cantilever straight spring assembly 203. FIG. 3 demonstrates the alignment of the grooved peg assembly 202 to the cantilever straight spring assembly 203 in the example embodiment.

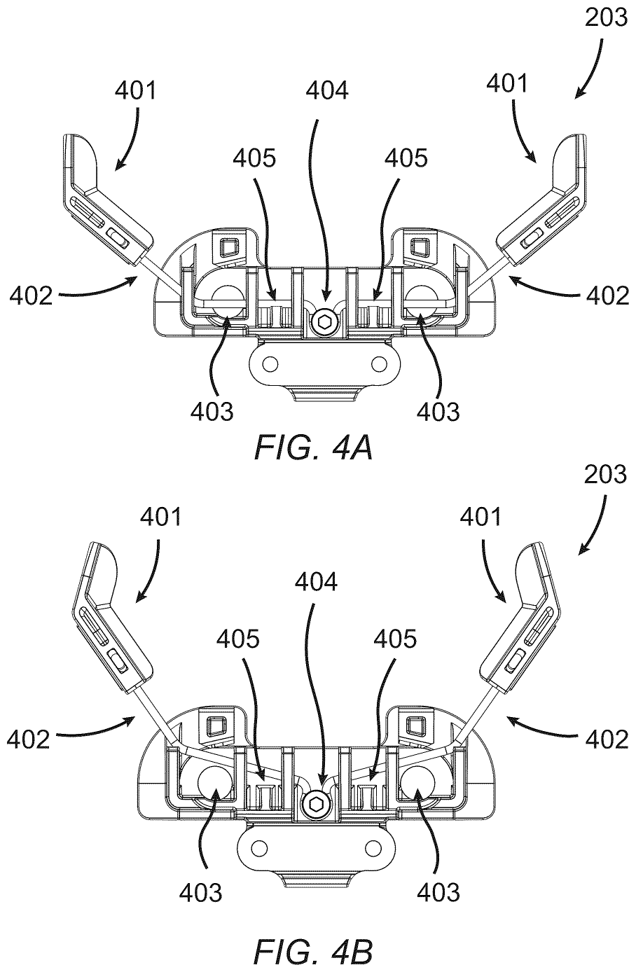

FIGS. 4A and 4B illustrate a cantilever straight spring assembly 203 from a top-down view. FIGS. 4A and 4B, each, comprise release handles 401, cantilever straight springs 402, alignment holes 403, a spring hinge bracket 404, and spring stop brackets 405. FIG. 4A illustrates the closed position of the cantilever straight spring assembly 203. FIG. 4B illustrates the open position of the cantilever straight spring assembly 203.

In the example embodiment, the spring hinge bracket 404 is the mount and hinge for the cantilever straight springs 402. In the example embodiment, two cantilever straight springs 402 are formed from a single piece of metal wire. A release handle 401 is attached at the lateral end of each cantilever straight springs 402. The cantilever straight spring 402 is manufactured in such a manner that, when no force is applied to the release handle 401 or cantilever straight spring 402, the cantilever straight spring 402 is in the closed position illustrated in FIG. 4A. The spring stop brackets 405 limit the forward movement of the cantilever straight spring 402, so the cantilever straight spring 402 is centered or nearly centered on the alignment hold 403, when no force is applied to the release handle 401 or cantilever straight spring 402.

When sufficient force is applied to a release handle 401 in the rearward direction, the respective cantilever straight spring 402 moves towards the rear of the model vehicle relative to the remaining portions of the cantilever straight spring assembly 203. Once the cantilever straight spring 402 has moved past the edges of the alignment hole 403, the cantilever straight spring assembly 203 is in the open position.

Other embodiments may use other materials than metal wire for the cantilever straight spring 402, such as, plastics or composite materials. Furthermore, some embodiments may mount one or more spring hinge brackets 404 at the ends of one or more respective cantilever straight springs 402, maintaining the ends of the wire in a fixed position and allowing the center portion of the wire to move. In such an embodiment, a release button may be pressed to move the one or more cantilever straight springs 402 past the edges of the one or more alignment hole 403, as opposed a release handle 401.

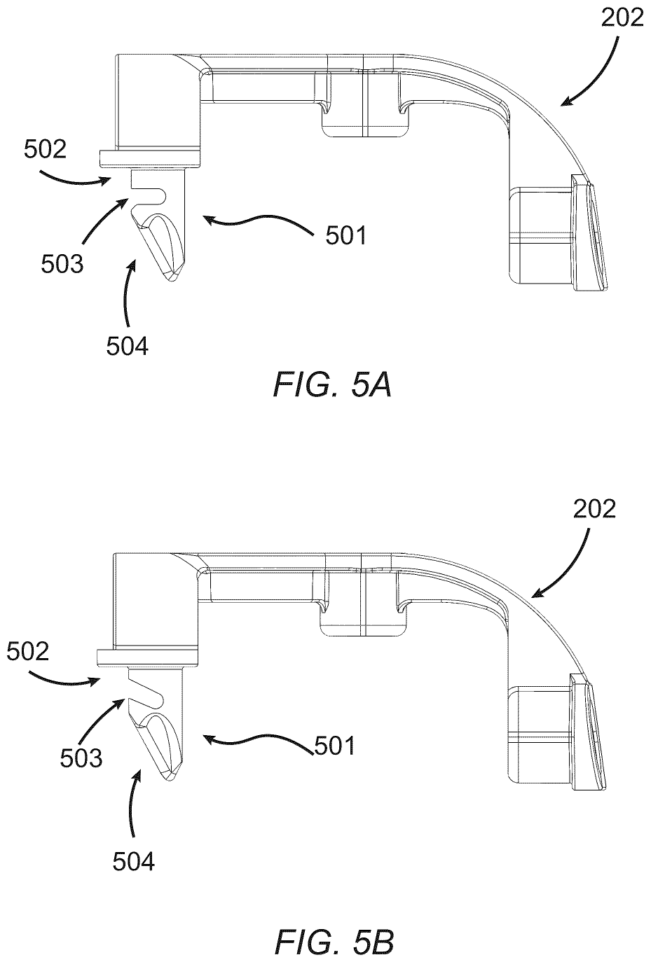

FIGS. 5A and 5B comprise a grooved peg assembly 202, grooved peg 501, peg stop 502, peg groove 503, and beveled edge 504. The grooved peg 501 and peg stop 502 are mounted to the grooved peg assembly 202. In both, FIGS. 5A and 5B, the grooved peg 501 is sized to allow the cantilever straight spring 403 to rest in the peg groove 503 when the cantilever straight spring assembly 203 is in the closed position. In FIG. 5A, the grooved peg 501 has a peg groove 503 cut flat into the front half of the grooved peg 501. While in FIG. 5B, the grooved peg 501 has a peg groove 503 cut a decline angle into the front half of the grooved peg 501, which may allow a more secure but less tight fitment between the grooved peg assembly 202 and cantilever straight spring assembly 203. Furthermore, the grooved peg 501 has a beveled edge 504.

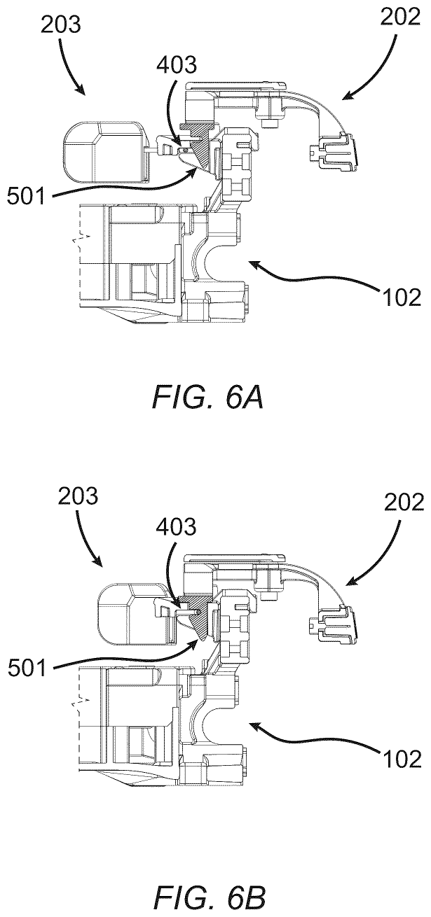

FIGS. 6A and 6B illustrate a side cut-out view of the quick-release body attachment mechanism in the open and closed positions, respectively. FIGS. 6A and 6B comprise the vehicle chassis 102, grooved peg assembly 202, cantilever straight spring assembly 203, cantilever straight spring 403, and grooved peg 501. FIG. 6A illustrates the cantilever straight spring assembly 203 in the open position, and the grooved peg assembly 202 in the partially inserted position. FIG. 6B illustrates the cantilever straight spring assembly 203 in the closed position, and the grooved peg assembly 202 in the fully inserted position.

When mating the grooved peg assembly 202 to the cantilever straight spring assembly 203, the insertion of the grooved peg 501 into the alignment hole 403 causes the beveled edge 504 push the cantilever straight spring 402 into the open position. Once in the open position, the grooved peg 501 is continually inserted until the cantilever straight spring 402 springs back into the closed position. The distance between the peg stop 502 and peg groove 503 is such that when the grooved peg assembly 202 is mated to the cantilever straight spring assembly 203 and downward force is applied to the vehicle body 102, the peg stop 502 engages the surface of the cantilever straight spring assembly 203, reducing the force transferred to the cantilever straight spring 402 from the grooved peg 501.

The above-disclosed subject matter is to be considered illustrative, and not restrictive, and the appended claims are intended to cover all such modifications, enhancements, and other embodiments that fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A clipless body attachment system for an RC vehicle comprising:
(a) a vehicle chassis having a cantilever straight spring assembly, the cantilever straight spring assembly comprising:
(i) a spring hinge bracket;
(ii) first and second cantilever straight springs extending laterally from the spring hinge bracket;
(iii) first and second spring stop brackets disposed on either side of the spring hinge bracket; and
(iv) first and second alignment holes, each of the first and second alignment holes comprising a perimeter; and
(b) a vehicle body configured to attach to the vehicle chassis, the vehicle body comprising first and second grooved peg assemblies, each of the first and second grooved peg assemblies comprising a peg groove configured to accept and securely hold each of the first and second cantilever straight springs;
wherein the cantilever straight spring assembly comprises an open position wherein the first and second cantilever straight springs are outside the perimeter of each of the first and second alignment holes; and
wherein the cantilever straight spring assembly comprises a closed position, wherein the first and second cantilever straight springs are within the perimeter of the first and second alignment holes.

2. The clipless body attachment system of claim 1, wherein the cantilever straight springs are formed of a single piece of metal wire.

3. The clipless body attachment system of claim 1, further comprising first and second release handles disposed on distal ends of the first and second cantilever straight springs from the spring hinge bracket.

4. The clipless body attachment system of claim 1, wherein each of the first and second grooved peg assemblies further comprises a peg stop and a beveled edge.

5. The clipless body attachment system of claim 4, wherein the peg groove is located between the peg stop and the beveled edge.

6. The clipless body attachment system of claim 1, wherein the peg groove is on a decline angle with respect to a horizontal axis of the RC vehicle, such that the vehicle body is more securely attached to the vehicle chassis.

7. A clipless body receiver for an RC vehicle chassis comprising:
(a) a cantilever straight spring assembly comprising:
(i) a spring hinge bracket;
(ii) first and second cantilever straight springs extending laterally from the spring hinge bracket;
(iii) first and second spring stop brackets disposed on either side of the spring hinge bracket; and
(iv) first and second alignment holes, each of the first and second alignment holes comprising a perimeter; and
wherein the cantilever straight spring assembly comprises a closed position, wherein the first and second cantilever straight springs are urged against the first and second spring stop brackets and within the perimeter of the first and second alignment holes;
wherein the cantilever straight spring assembly comprises an open position wherein the first and second cantilever straight springs are outside the perimeter of each of the first and second alignment holes.

8. The clipless body receiver of claim 7, wherein the closed position is a default position at such time as no outside force is acting on the first and second cantilever straight springs.

9. The clipless body receiver of claim 7, wherein the cantilever straight spring assembly is urged into the open position when a compressive force is acted upon a distal end of each of the first and second cantilever straight springs.

10. The clipless body receiver of claim 7, wherein the cantilever straight spring assembly is configured to be urged into the open position when a vehicle body having first and second grooved peg assemblies, each of the first and second grooved peg assemblies comprising a leading beveled edge is urged into the first and second alignment holes, each of the first and second leading beveled edges urging the first and second cantilever straight springs to the open position.

11. The clipless body receiver of claim 10, wherein the cantilever straight spring assembly is configured to return to the closed position upon full insertion of the first and second grooved peg assemblies such that the first and second cantilever straight springs snap into a peg groove within each of the first and second grooved peg assemblies.

12. A clipless body attachment system for an RC vehicle comprising:
(a) a vehicle chassis having a cantilever straight spring assembly, the cantilever straight spring assembly comprising:
(i) a spring hinge bracket;
(ii) a cantilever straight spring extending laterally from the spring hinge bracket;
(iii) a spring stop bracket disposed on a side of the spring hinge bracket; and p2 (iv) an alignment hole comprising a perimeter; and
(b) a vehicle body configured to attach to the vehicle chassis, the vehicle body comprising a grooved peg assembly, the grooved peg assembly comprising:
(i) a peg stop;
(ii) a beveled edge extending downwardly from the vehicle body;
(iii) a peg groove disposed between the peg stop and the beveled edge;
wherein the cantilever straight spring assembly comprises an open position wherein the cantilever straight spring is outside the perimeter of the alignment hole; and
wherein the cantilever straight spring assembly comprises a closed position, wherein the cantilever straight spring is within the perimeter of the alignment hole.

13. The clipless body attachment system of claim 12, wherein the wherein the peg groove is on a decline angle with respect to a horizontal axis of the RC vehicle, such that the vehicle body is more securely attached to the vehicle chassis.

14. The clipless body attachment system of claim 12, wherein the closed position is a default position at such time as no outside force is acting on the cantilever straight spring.

15. The clipless body attachment system of claim 12, wherein the cantilever straight spring is a first cantilever straight spring, the spring stop bracket is a first stop bracket, and the alignment hole is a first alignment hole, the cantilever straight spring assembly further comprising:
(i) a second cantilever straight spring extending laterally from the spring hinge bracket in a direction opposite the first cantilever straight spring;
(ii) a second spring stop bracket disposed on a side of the spring hinge bracket opposite from the first spring stop bracket; and
(iii) a second alignment hole comprising a perimeter on a side of the spring hinge bracket opposite the first alignment hole.

16. The clipless body attachment system of claim 15, wherein the first and second cantilever straight springs are formed of a single piece of metal wire.
